(19) United States
(12) Patent Application Publication
(10) Pub. No.: US 2006/0055730 A1
(43) Pub. Date: Mar. 16, 2006

(54) Ink jet recording apparatus

(75) Inventors: Yoshihiko Ono, Kanagawa (JP); Yoshiro Yamashita, Kanagawa (JP)

Correspondence Address: FILDES & OUTLAND, P.C., 20916 MACK AVENUE, SUITE 2, GROSSE POINTE WOODS, MI, 48236, US

(73) Assignee: Fuji Xerox Co., Ltd.

(21) Appl. No.: 11/062,405

(22) Filed: Feb. 22, 2005

(30) Foreign Application Priority Data
Sep. 16, 2004 (JP) 2004-270161

(51) Int. Cl. B41J 2/165

(52) U.S. Cl. 347/36

(57) ABSTRACT

The present invention provides an ink jet recording apparatus which has a recording head having at least one nozzle which ejects liquid droplets of ink to record an image on a recording medium. The ink jet recording apparatus includes a mist collecting device for collecting a mist that does not impact against the recording medium and a catalytic decomposing device for decomposing organic components in the mist by means of a catalyst. The catalyst is preferably a photo semiconductor catalyst. Further, the apparatus preferably has an air suction device and/or a collector for collecting the mist. The catalytic decomposing device also preferably has a light irradiation device.

This application claims priority under 35 USC 119 from Japanese Patent Application No. 2004-270161, the disclosure of which is incorporated by reference herein.

### BACKGROUND OF THE INVENTION

1. Field of the Invention

The present invention relates to an ink jet recording apparatus that ejects liquid droplets of ink from a recording head onto a recording medium for recording.

2. Description of the Related Art

Recently, there has been a striking prevalence in the use of colored documents in the office, and because of this a variety of output machines to be proposed. In particular, ink jet recording apparatuses, which can be made compact and are of low-cost, have been used in a variety of output machines.

An ink jet recording apparatus having an ink jet recording head that records an image on recording sheets of paper (recording medium) by discharging liquid droplets of ink from nozzles, generates an ink mist (mist). Ink mist means small liquid droplets that are separated from the outermost region of a liquid droplet of ink when a liquid droplet of ink is expelled from a nozzle, or small liquid droplets that are produced by a rebound of a liquid droplet of ink against a recording sheet of paper. Small liquid droplets of this ink mist move irregularly in paths different from those of the liquid droplets of ink which impact against a recording sheet of paper. Since they drift within the ink jet recording apparatus, they cause problems of staining recording sheets and the inside of the ink jet recording apparatus.

Particularly recently, a configuration of a machine has been proposed that provides a head that expels a treating liquid, containing a material that makes insoluble and agglomerates coloring material in an ink, and is separate from the ink discharge. This is proposed as a means of improving water fastness of images and enhancing image quality by suppressing the spread between different colors (e.g., see Japanese Patent Application Laid-Open (JP-A) Nos. 8-72234 and 8-281931). In association with such an increase in speed and image quality enhancement, a satellite component (micro liquid droplets) is formed ancillary to the main liquid droplets during liquid droplet ejection, and this, together with ink and treating liquid generated by rebounding of liquid droplets of ink and the like on the recording medium, adhere to the liquid droplet ejection orifice formation surface and the linear encoder, for the carriage position information detection. This causes trouble such as discharge failure, position detection failure, and the like, leading to serious problems.

As solutions to these problems, proposed are a process that involves providing a cover plate on the near surface of ink ejection orifices, and controlling the adhesion surface of the rebound mist using a generated scanning airflow (e.g., refer to JP-A No. 9-216352), and a process that entails separating the relative distance between reaction discharge heads and ink discharge heads to reduce mixing of the ink and treating liquid (e.g., refer to JP-A No. 2000-141713).

These means alone, however, are not sufficiently effective when a large amount of mist is generated, including in so-called full line head printers, which is provided with plural discharge ports over the entire width for high-speed/large scale printing and recording regions. Here the problem of mist recovery remains unsolved.

### SUMMARY OF THE INVENTION

The present invention has been made in view of the above circumstances and provides an ink jet recording apparatus capable of reducing the generation of problems within the apparatus due to mist, even under conditions where a large amount of mist is generated during ink jet recording. It also is capable of prolonging the life of mist collecting devices and also gives consideration to environmental measures.

Namely, the invention provides an ink jet recording apparatus which comprises a recording head having at least one nozzle which ejects liquid droplets of ink to record an image on a recording medium, wherein the ink jet recording apparatus includes a mist collecting device for collecting a mist that does not impact against the recording medium and a catalytic decomposing device for decomposing organic components in the mist using a catalyst.

### BRIEF DESCRIPTION OF THE DRAWINGS

FIG. 1 is a schematic diagram showing the primary elements of an ink jet recording apparatus in the present invention.

FIG. 2 is a schematic pattern diagram showing the primary elements of a typical ink jet recording apparatus in the invention.

FIGS. 3A and 3B are, respectively, a top view to an airflow direction and a side view to the airflow direction of an illustrative configuration form and shape of a mist collecting and catalytic decomposing device.

FIGS. 4A and 4B are, respectively, a top view to an airflow direction and a side view to the airflow direction of another illustrative configuration form and shape of a mist collecting and catalytic decomposing device.

FIG. 5 is a diagram showing a relationship between the number of prints and ΔOD (an index of stain).

### DETAILED DESCRIPTION OF THE INVENTION

The present invention will be described in detail hereinafter.

The invention is an ink jet recording apparatus that ejects liquid droplets of ink from the nozzles of the recording head to record an image on a recording medium. The recording apparatus characteristically includes a mist collecting device for collecting mist that does not impact against the aforementioned recording medium, and a catalytic decomposing device for decomposing organic components in the mist by means of a catalyst.

The configuration of the invention enables the collection of a mist generated during ink jet recording as well as enabling the decomposition of organic components in the collected mist. This makes it possible to stably collect mist over a long period of time even though a large amount of mist is generated in ink jet recording in association with high speed printing and image quality enhancement. This enables discharge failures and poor image quality to be avoided.

An ink jet recording apparatus of the invention will specifically be described in reference to drawings hereinafter.

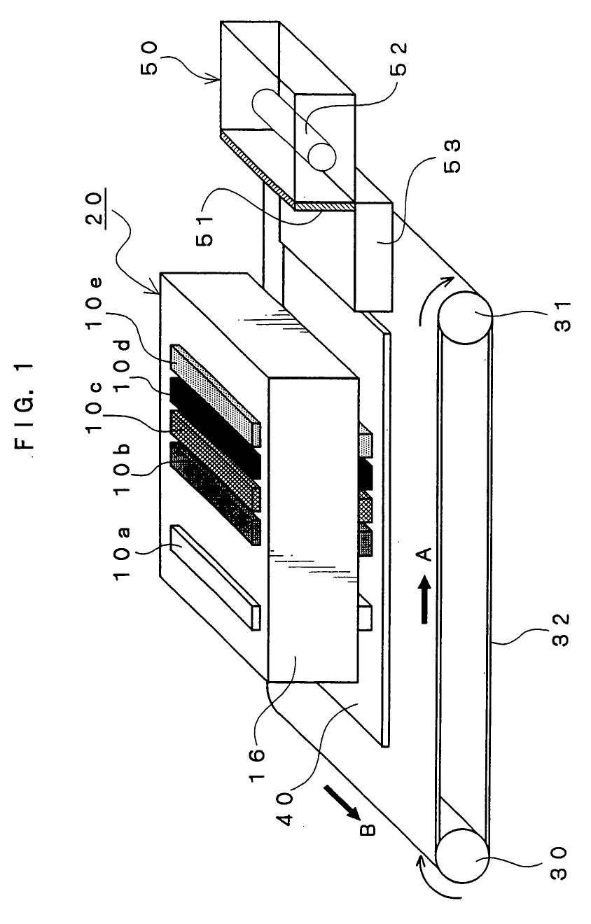

FIG. 1 illustrates the primary elements of an ink jet recording apparatus of the invention.

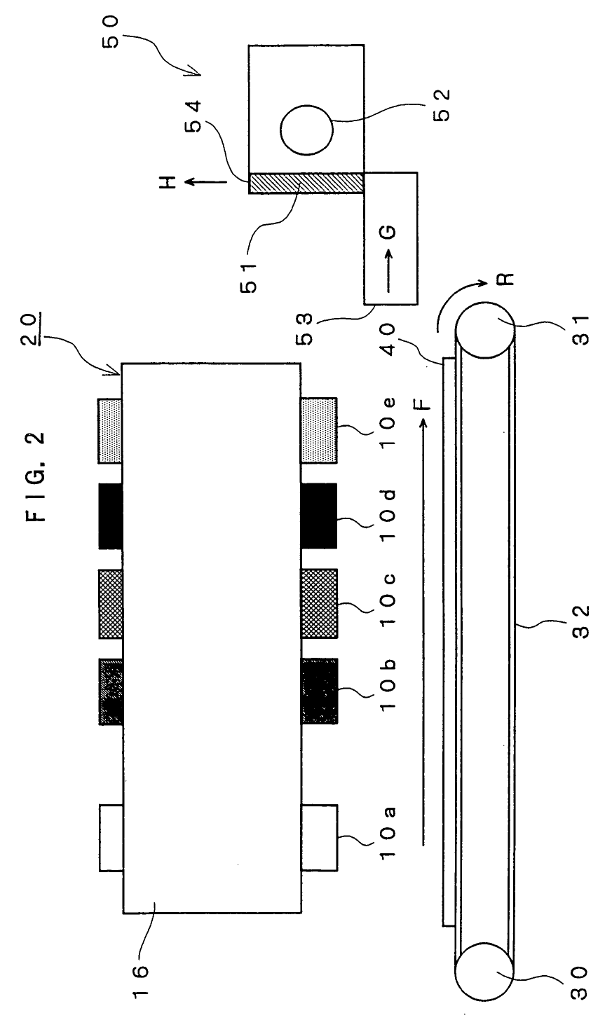

The ink jet printer includes a fixed recording head 20; the recording head 20 is provided with five heads 10. Nozzle surfaces 10a to 10e (see FIG. 2), which are mounted on the head 10, are disposed so as to face a recording paper sheet 40 (recording medium). The nozzle arrays in the nozzle surfaces 10a to 10e are disposed over the entire width (entire width of a recording region) in the direction of the arrow B of the recording paper sheet 40. While the recording paper sheet 40 is conveyed in the arrow A direction, by means of a paper sheet conveying belt 32 that extends between two rolls 30 and 31, an image is recorded on the recording paper sheet 40 according to image information by the ejection of liquid droplets of ink, from the recording head 20 towards the conveyed recording paper sheet 40, onto the recording paper sheet 40 convey.

A recording head of the invention may be a recording head that is scanned in the width direction of the recording paper sheet 40, as will be described below, and not fixed as described above.

The ink jet printer indicated in FIG. 1 uses a two-liquid ink set that comprises ink that discharges as liquid droplets of ink and a treating liquid that has the function of aggregating the pigment of the ink. The invention, however, includes the form where liquid droplets of ink are expelled without the use of the aforementioned treating liquid. The above ink and treating liquid will be described in detail later.

Here, the recording paper sheet 40 is utilized as the recording medium, however, the media may include a film and an OHP sheet in place of the paper sheet. The recording paper sheet 40 may also be a roll shape or a strip of paper and is not limited.

On the side located downstream of the recording paper sheet in the conveying direction relative to the recording head 20 (right-hand side in the drawing), a mist collecting device 50 is provided that includes a collector 51 that collects mist and a black light 52 (light irradiation device) that irradiates the collector 51 with near ultraviolet light.

FIG. 2 is a side view of the primary elements of the ink jet printer, viewed from the axis direction of the rolls 30 and 31. FIG. 2 shows a conveying device that conveys a sheet of paper in one direction, the direction orthogonal to the diagram depth direction of the nozzle arrays (not shown), and the opposing nozzle surfaces 10a to 10e of the recording head 20 as shown in FIG. 1, It also shows a mist collecting device, the other constitutions are omitted. In addition, in FIG. 2, reference numeral 16 shows the recording head body portion, reference numerals 30 and 31 show the rolls, reference numeral 32 shows the paper sheet conveying belt, reference numeral 40 shows the recording medium, reference numeral 50 shows the mist collecting device, and other symbols and marks are the same as those shown in FIG. 1.

On the nozzle surfaces 10a to 10e side of the recording head 20 is provided the conveying device that conveys the recording medium 40 with facing the recording medium 40 to the nozzle surfaces 10a to 10e; the conveying device includes the roll 30 located upstream of the flow direction F of an airflow, the roll 31 located downstream of the flow direction F of the airflow, and the endless paper sheet conveying belt 32 extended on the two rolls 30 and 31; the paper sheet conveying belt 32 is capable of being rotated in the arrow R direction by a driving device (not shown).

The recording medium 40 is supplied to the paper sheet conveying belt 32 on the outer top surface of the roll 30 on the side on which the recording head 20 is disposed by a paper sheet supplying device (not shown). It is conveyed from the roll 30 side to the roll 31 side by a revolutionary movement in the arrow R direction of the paper sheet conveying belt 32. During the conveying process, a variety of printing liquids are ejected, as appropriate according to the image information, from the nozzle arrays of the nozzle surfaces 10a to 10e to form an image (print) on the recording head 20 side (surface) of the recording medium 40. After the image has printed on the recording medium 40 it is discharged on the roll 31 side outside of the machine.

The aforementioned nozzle arrays may comprise plural nozzles that eject uniform printing liquid and which are placed in series. Or the printing liquid discharged from a nozzle array can be supplied from, for example, a printing liquid supply source such as an ink tank mounted in the upper portion of the recording head 20. Any well known process can be utilized as a method for discharging a printing liquid. Examples include the so-called piezo ink jet system, that uses a piezoelectric element, and the so-called thermal ink jet system, that involves supplying heat energy forming liquid droplets and recording an image.

Nozzle arrays may be provided with each array on a nozzle surface, and with two or more arrays placed in parallel. For instance, when four nozzle arrays (four nozzle surfaces) are disposed, nozzles can eject inks of cyan, magenta, yellow, and black. When five nozzle arrays are disposed, nozzles can eject the treating liquid, as well as inks of cyan, magenta, yellow, and black.

In the example indicated in FIG. 2, for instance, the nozzle array disposed on the nozzle surface 10a can eject a treating liquid, the nozzle array disposed on the nozzle surface 10b can eject a black ink, the nozzle array disposed on the nozzle surface 10c can eject a cyan ink, the nozzle array disposed on the nozzle surface 10d can eject a magenta ink, and the nozzle array disposed on the nozzle surface 10e can eject a yellow ink.

In the configuration shown in FIGS. 1 and 2, a flow of air is generated (arrow F direction) between the recording medium 40 and the side of the nozzle surfaces 10a to 10e of the recording head 20. This direction is the same as the direction of the recording medium 40 conveying and the air flow is generated during the conveying of the above recording medium 40. The ejection of ink and treating liquid from the nozzle arrays during printing also generates a mist (liquid droplets which are not impacted against a recording medium) in addition to main liquid droplets that contribute to the formation of an image (liquid droplets being impacted on the recording medium).

In order to solve the above-described problem, the configuration shown in FIGS. 1 and 2 is provided with a mist collecting device. Specifically, the ink jet printer as shown in FIG. 2 is provided with the mist collecting device 50 downstream of the recording head 20 in the flow direction of the air (arrow F direction) which can efficiently collect the generated mist. By doing so it can prevent: deterioration of an image formed on the recording medium 40 surface; staining of the inside of the ink jet recording apparatus, such as the nozzle surfaces 10a to 10e and the outer peripheral surface of the paper sheet conveying belt 32 arising from the adhesion and accumulation of mist; as well as secondary issues (ejection failure, etc.) associated with the staining.

More specifically, mist generated below the nozzle surfaces 10a to 10e in the diagram during the printing of an image onto the recording sheet of paper 40 flows together with air in the arrow F direction. It is sucked into a mist suction inlet 53 in the mist collecting device 50, and the mist moves in the arrow G direction within the mist collecting device 50 and in turn is absorbed into the collector 51. Thereafter, air without mist is discharged from the outlet 54 of the mist collecting device 50 in the arrow H direction.

As described above, if mist generated in the printing region of the recording head 20 is always efficiently collected by the mist collecting device 50, no special problems arise. However, when the amount of mist generation is increased due to image quality enhancement and high speed printing features, as described above, the collection capability of the collector 51 is rapidly decreased. This leads to frequent changes of the collector 51, or causes stains or image quality failure inside or outside the above apparatus because of clogging in the collector if the collector is not changed. Moreover the mist not to be collected by the mist collecting device 50 is directly discharged out of the machine, posing serious problems for the use of the apparatus use as well as from the environmental viewpoints.

This invention includes a catalytic decomposing device for decomposing organic components in a mist that is collected with the collector 51 by a catalyst to address the above problems. This enables the decomposition of organic components as they collect, so the collector 51 can always be kept clean, preventing deterioration in the collection capability. As such, mist can stably be collected.

The term “organic components in the above mist” stands for organic components, for example, vehicles such as resin components and dispersant components as well as organic solvents contained in the ink.

The configuration of the aforementioned catalytic decomposing device is not particularly limited as long as the catalyst has a form that makes decomposition possible. The ink jet printer as indicated in FIG. 2 has the collector 51 that is made to carry titanium oxide (TiO₂), which is a photo semiconductor catalyst, as a catalyst, and the collector 51 is irradiated, by a black light (light irradiating device, central wavelength: 352 nm), with light in a wavelength region absorbed by titanium oxide (about 400 nm or less) for the decomposition of organic components in the collector 51. Hence, this case includes a catalytic decomposing device within the mist collecting device 50.

The catalytic decomposing device in the invention is not limited to the above configuration. An example of configuration may include separating the organic components absorbed in the collector 51 from the collector 51 within the apparatus by some method, and subsequently decomposing the separated organic components with light irradiation by use of decomposition space that is separately provided and is coated with titanium oxide.

The timing and duration of the above light irradiation are not particularly limited. For instance it is sufficient that there is only exposure to light radiation during the aforementioned printing periods. The collector, catalyst, near ultraviolet irradiation, and the like will be described in detail below.

The mist collecting device 50 may have an air sucking device provided in such a way that the airflow of the arrow F direction containing the aforementioned mist can be efficiently sucked. This air sucking device may also be, for example, a configuration that has the mist collecting device 50 having the outlet 54 provided with a fan (not shown). The generation of airflow by the driving of the fan enables more effective collection of a mist from the suction inlet 53 facing the printing region.

In addition, the setting position of the aforementioned fan is not particularly limited so long as it is within an ink jet printer. Also the airflow may be discharged from the back (depth side in the diagram) of an ink jet printer by turning the discharge port 54. The absorption flow rate may be controlled by disposition of plural fans.

The position at which the mist collecting device 50 (sometimes including a catalyst decomposing mean) is located is not particularly limited. Preferably, the collecting device is disposed downstream in the airflow containing mist as indicated in FIG. 2.

As for the direction of airflow generation during printing, in a so-called single-pass type ink jet recording apparatus, which includes fixed type recording head(s) (full-line head) having a width almost the same as the length of a recording medium orthogonal to the conveying direction of the recording medium (print region), an airflow is generated that flows in single direction relative to the nozzle surface on a macroscopic scale, since the recording medium is conveyed in a single direction relative to the nozzle surface.

On the other hand, in a so-called multi-pass type ink jet recording apparatus, which includes a scanning type recording head capable of a scanning in the direction perpendicular to the conveying direction of a recording medium, an airflow is generated that flows in one direction relative to the nozzle surface or the opposite direction on a macroscopic scale, since the nozzle surface moves in both directions relative to the recording medium surface.

More specifically, the airflow generated relative to the nozzle surface during printing is formed in the direction parallel to the nozzle surface on a macroscopic scale.

Accordingly, when a mist collecting device in the invention is applied to a so-called single-pass type ink jet recording apparatus, the fixation of the ink jet recording apparatus such that the mist collecting device is located downstream of the recording medium conveying direction makes it possible to efficiently collect the mist generated from outside the nozzle array located on the downstream side of the recording medium in the conveying direction.

When the mist collecting device in the invention is applied to a multi-pass type ink jet recording apparatus, the mist collecting device is disposed on the ink jet recording apparatus so as to be located on both sides of the recording head in the scanning direction, thereby being capable of efficiently collecting mist from outside the nozzle arrays located on both sides of the recording head in the scanning direction.

Where the above-described single-pass and multi-pass systems are compared, the single-pass system is preferable because the degree of freedom for locating the mist collecting device where there is no disturbance of the airflow by the scanning of the recording head is larger.

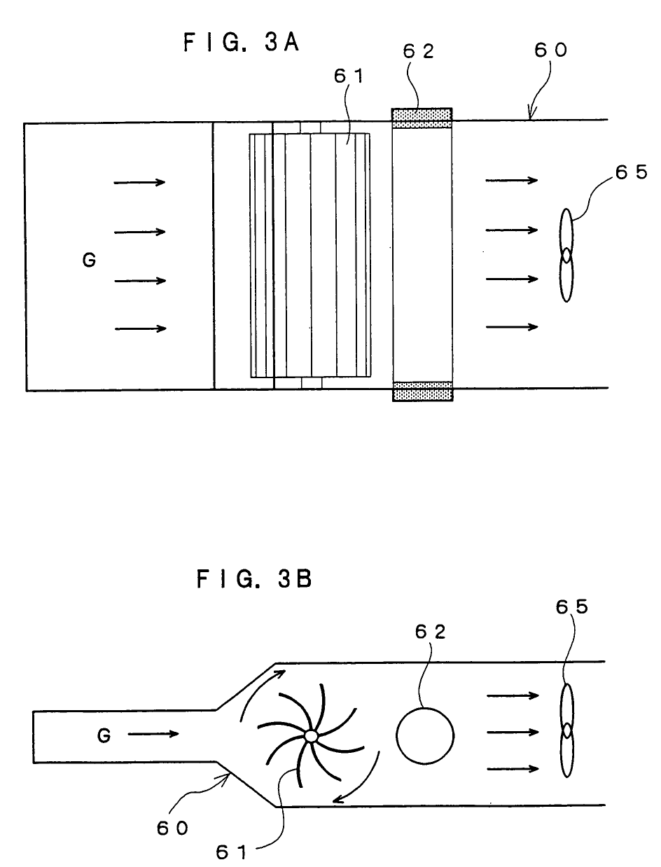

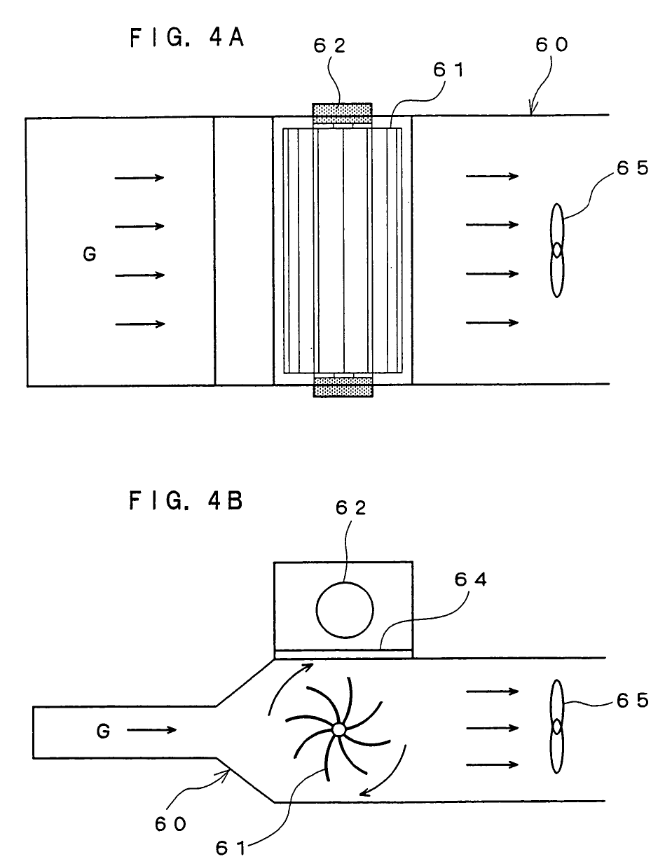

The configuration and shape of the mist collecting device in the invention are not limited to the configurations and shapes as shown in FIGS. 1 and 2; for example, the configurations and shapes as indicated in FIGS. 3A and 3B and 4A and 4B are acceptable.

FIGS. 3A and 3B are schematic views indicating another example of a configuration and shape of a mist collecting device 60; FIG. 3A is a top view relative to an airflow direction (the direction of from the top in FIG. 1) and FIG. 3B is a side view relative to the airflow direction (the direction from the front side in FIG. 1).

In FIGS. 3A and 3B, reference numeral 61 represents a collector, reference numeral 62 a black light, and reference numeral 65 a fan. In the configuration indicated in FIG. 3, the collector 61 is a vane shape, the surface of which is coated with titanium oxide, which is a photocatalyst. Rendering the collector 61 to be such a shape a mist can be efficiently collected by means of a wide collecting area, while the position of the collecting portion is always changed, without disturbing the airflow in the arrow G direction, generated by the fan 65.

The black light 62 is placed downstream of the collector 61 and illuminated concurrently with the rotation of the collector 61 during printing, irradiating the collector 61 with light. The light irradiation allows the titanium oxide on the collector 61 surface to act as a catalyst, whereby the catalyst decomposes the organic components in mist present on the collector 61 surface. In this case, the collector 61 of a vane shape is rotating as described above, so light irradiation is carried out completely uniformly, and thus the above organic components are efficiently broken down.

The mist collecting device 60 shown in FIG. 4 basically has the same configuration as the mist collecting device indicated in FIG. 3, except for a change in the disposition location of the black light 62. The substance of FIGS. 4A and 4B (the directions of viewing the mist collecting device) are the same as the ones in FIGS. 3A and 3B.

In the mist collecting device 60 as indicated in FIGS. 4A and 4B, the black light 62 is not present in the airflow direction as shown in FIGS. 3A and 3B but is disposed directly above the collector 61 (upward of the sheet face in FIG. 4B). The disposition of the black light 62 is preferably as close to the collector 61 as possible from a standpoint of the exposure of the titanium oxide of the collector 61 to sufficient light radiation. However, when the black light 62 is present somewhere along the airflow, as shown in FIGS. 3A and 3B, the black light 62 is stained with mist that cannot be collected by the collector 61, decreasing the amount of irradiation light.

As such, the configuration as indicated in FIGS. 4A and 4B has the black light 62 disposed directly above collector 61 and has a cover 64 such that airflow does not enter the black light. Such a configuration can irradiate the collector 61 with light, with the black light close to the collector 61, and can also avoid staining the black light 62 with mist arising from continuous use.

Next, the collector, the catalyst, the near infrared radiation device, and the like in the aforementioned mist collecting device and the catalytic decomposing device will be described.

The collector in the mist collecting device may have a structure that does not allow airflow (air) to pass through, but preferably has a structure that does allow airflow (air) to pass through. The latter structure may, for example, comprise a porous body or fibers. The pore diameter and porosity of the porous body, the void size between fibers, the fiber diameter, and the like, however, are required to be such that mist will not pass through, or they need to be of such a size that mist is collected inside or on the surface the porous body, fibers, or the like comprising the collector.

Also, the materials for forming the collector are not limited, and examples that may be utilized include well known materials such as natural and synthetic resin and rubbers, felt material, metals, ceramics and paper, but water-absorbing materials are preferable.

However, when the collector is made to carry a catalyst such as titanium oxide as described above, the collector is also preferably a material that is not itself decomposed by titanium oxide, and the like. Examples that are preferably utilized include metals such as SUS stainless steel, ceramics, polyesters, and acrylics and the like.

The shape and form of the collector is also not particularly limited as long as mist which approaches the collector can be collected without passing through. Examples including shapes such as a film shapes, fiber shapes or composite shapes thereof, in addition to the flat plate shape and vane shape as mentioned above. Also, even when the collector is made to be one of the various shapes mentioned above, the collector is preferably extended over the entire area of the mist collecting device through which the airflow passes, in order to collect mist thoroughly from the sucked airflow.

The catalyst that is used for the catalytic decomposing device in the invention is not particularly limited so long as the catalyst can breakdown organic components. However a photo semiconductor catalyst is preferably used from the standpoint that decomposition is possible merely by using light irradiation, as well because of its high decomposition efficiency.

The above photo semiconductor catalyst generally means a material which is generally excited by light irradiation, generating a pair comprising an electron and a hole, which causes the reaction of adsorbed molecules and the like, by the dispersion of the electron and hole pair. The photo semiconductor catalyst in the invention decomposes organic components adsorbed on its surface into water and carbon dioxide by the above photo-excitation.

Examples of the aforementioned photo semiconductor catalysts may include titanium oxide, strontium titanate, zinc oxide, and copper. Among these, titanium oxide has the greater capability to decompose organic materials under light irradiation, and thus is preferable. In addition, among titanium oxides, anatase type titanium oxide is high in activity when compared with rutile type and amorphous type titanium oxides and is hence more preferable.

The degree of decomposition of organic components for the same amount of light irradiation in the invention is thought to be proportional to the light excitation efficiency of the photo catalyst material. In general, the smaller the particle diameter of the photo semiconductor catalyst and the larger the specific surface area is, the higher the aforementioned light excitation efficiency becomes and the larger the decomposition capability becomes. The average particle diameter of a photo semiconductor catalyst used in the invention is preferably in a range of from about 4 to 180 nm, more preferably in a range of from about 6 to 30 nm. If the average particle diameter is below about 4 nm, not only is their production difficult but also handling properties sometimes cause a problem. If the average particle diameter exceeds about 180 nm, the photo semiconductor catalyst does not have sufficient activity in some cases.

The specific surface area is almost inversely proportional to the above average particle diameter, and in the invention it is preferably in a range of from about 9 to 350 m²/g, more preferably in a range of from about 50 to 260 m²/g.

The above-described photo semiconductor catalysts may be used singly, or in a mixture of two or more photo semiconductor catalysts.

Use of the above-described photo semiconductor catalyst requires fixation of the photo semiconductor catalyst on the substrate surface by some method or other, whether the catalyst is supported on the collector as described above or the catalyst is made to be present in a decomposition space. The methods of fixation may include a variety of methods such as coating by use of a binder resin, high temperature baking and vapor deposition. Among these, coating by use of a binder resin is preferable in view of ease of production.

The above binder resin is not limited so long as the resin can render the photo semiconductor catalyst uniformly dispersed. However, the resin should not be easily decomposed by active oxygen produced by light excitation of the photo semiconductor catalyst. In terms of this, preferable binder resins include fluorine resins, and silicone resins.

A sol-like slurry prepared by dispersion of a photo semiconductor catalyst having the aforementioned average particle diameter in water, an alcohol, toluene, or the like may be used as the coating liquid. Or the slurry may be further re-dispersed in an organic solvent and the like for use. The above coating liquid may also be used in combination with the aforementioned binder resin or another inorganic component, or in combination with a dispersant such as another binder or a surfactant, a coupling agent, or the like.

A normal coating method such as a spray process, dipping process, or spin coating process may be utilized as the coating method. After coating, the coated substrate may be dried at room temperature or heat dried at from about 100 to 140° C. Alternatively, prior to the above coating, a primer layer may also be formed to enhance adhesiveness, or a protecting layer may also be formed to prevent deterioration by the photo catalyst.

The thickness of photo semiconductor catalyst layer after drying is preferably in a range of from about 0.1 to 10 μm.

The photo semiconductor catalyst layer has a surface thus formed in order for the photo semiconductor catalyst to directly control the decomposition of organic components, so if the surface of the photo semiconductor catalyst is covered with a binder and the like, this leads to a decrease in photo catalytic action proportional to the coverage ratio. This requires the exposure of the above photo semiconductor catalyst to the outermost surface of the charged member to be a certain ratio or above. This ratio is preferably about 50% or more in terms of the surface percentage of the entire surface.

A light irradiation device in the invention is required particularly when a photo catalyst like the aforementioned photo semiconductor catalyst is used. For the above light irradiation device, the wavelength region excited by light varies depending on the photo catalyst material, and thus the light to be irradiated needs to contain wavelengths by which a photo catalyst, such as the aforementioned photo semiconductor catalyst, is excited.

Most of the above mentioned photo semiconductor catalysts have a wavelength absorption region of about 400 nm and below, so a light irradiation device in the invention can preferably irradiate matter with near ultraviolet light or ultraviolet light having a wavelength of about 400 nm or below. Such light irradiation devices that may be used include a xenon lamp, a high-pressure mercury lamp, a black light, a bactericidal lamp and the like.

The light intensity is preferably in a range of from about 0.01 to 10 mJ/cm².s for the purpose of obtaining a sufficient decomposition efficiency in a short time of light irradiation, more preferably in a range of from about 0.2 to 1 mJ/cm².s.

Now, ink and treating liquid that can be used in the invention will be described.

A colored ink containing a pigment, a water-soluble solvent and water, and a treating liquid having the function of aggregating the pigment of the ink may suitably be used as printing liquids ejected from the nozzles of recording heads. In the present embodiment, a treating liquid is used separately from an ink as described above, but the treating liquid may be used as an ink (e.g., yellow ink), the treating liquid being made to contain a pigment.

The ink includes at least a pigment, a water-soluble solvent and water.

The pigment may use any of an organic pigment and an inorganic pigment, and black pigments include carbon black pigments such as furnace black, lamp black, acetylene black and channel black. In addition to the black pigments and three primary colors of cyan, magenta, and yellow, other pigments such as specific color pigments of red, green, blue, brown, white, and the like, metal gloss pigments of gold color, silver color, and the like, and extender pigments of colorless or pale color, plastic pigments, and the like may also be used. A pigment that is newly synthesized for the invention may also be used.

Specific examples of black pigments include, but are not limited to, RAVEN 7000, RAVEN 5750, RAVEN 5250, RAVEN 5000, ULTRA II, RAVEN 3500, RAVEN 2000, RAVEN 1500, RAVEN 1250, RAVEN 1200, RAVEN 1190, RAVEN 1170, RAVEN 1255, RAVEN 1080, and RAVEN 1060 (trade names, manufactured by Columbian Chemicals Company); REGAL® 400R, REGALE 330R, REGAL® 660R, MOGUL® L, BLACK PEARLS® L, MONARCH® 700, MONARCH® 800, MONARCH® 880, MONARCH® 900, MONARCH® 1000, MONARCH®1100, MONARCH® 1300, and MONARCH® 1400 (trade names, manufactured by Cabot Corporation); Color Black FW1, Color Black FW2, Color Black FW2V, Color Black 18, Color Black FW200, Color Black S150, Color Black S160, Color Black S170, Special Black 6, Special Black 5, Special Black 4A, and Special Black 4 (trade names, manufactured by Degussa), PRINTEX® 35, PRINTEX® U, PRINTEX® V, PRINTEX® 140U, and PRINTEX® 140V (manufactured by Degussa); No. 25, No. 33, No. 40, No. 47, No. 52, No. 900, No. 2300, MCF-88, MA 600, MA 7, MA 8, and MA 100 (trade names, manufactured by Mitsubishi Chemical Co., Ltd.).

Cyan colors include, but are not limited to, C. I. Pigment Blue-1, -2, -3, -15, -15:1, -15:2, -15:3, -15:4, -16, -22, and -60.

Magenta colors include, but are not limited to, C. I. Pigment Red-5, -7, -12, -48, -48:1, -57, -112, -122, -123, 146, -168, -184, and -202.

Yellow colors include, but are not limited to, C. I. Pigment Yellow-1, -2, -3, -12, -13, -14, -16, -17, -73, -74, -75, -83, -93, -95, -97, -98, -114, -128, -129, -138, -151, and -154.

In addition, a pigment that is self-dispersible in water may be employed as the pigment. A pigment that is self-dispersible in water is a pigment that has many water-soluble groups on the surface of a pigment and is stably dispersed in water without a presence of a macromolecule dispersing agent. Specifically, for example, a pigment that is self-dispersible in water is obtained by surface modifying treatment of a usual so-called pigment, suxh as acid and base treatment, coupling agent treatment, polymer graft treatment, plasma treatment, or oxidation/reduction treatment.

Examples of pigments which are capable of being self-dispersed in water include CAB-O-JET® 200, CAB-O-JET® 200, IJX™ 253, IJX™ 266, IJX™ 444, IJX™ 273, and IJX™ 55 (manufactured by Cabot Corporation), MICROJET BLACK CW-1, and CW2 (trade names, manufactured by Orient Chemical Industries, Ltd.), which are commercially available, in addition to the pigments prepared by surface modifying treatment of the above pigments.

The amount of pigment that is used is from about 0.5 to 20% by weight, preferably from about 1 to 10% by weight, based on the amount of ink. If the amount of pigment in ink is less than about 0.5% by weight, a sufficient optical density cannot be obtained in some cases, and if the amount of pigment exceeds about 20% by weight, ejection characteristics of ink sometimes become unstable.

A macromolecule dispersing agent may be added to ink used in the invention for the purpose of dispersing the pigment in the ink. When a pigment that is self-dispersible in water is used, a macromolecule dispersing agent may also be added as a macromolecule material. Examples of the macromolecule dispersing agents that may be utilized in the invention include a nonionic compound, an anionic compound, cationic compound, and an amphoteric compound, the examples that may be used including copolymers of monomers having an a, β-ethylenic unsaturated group.

Specific examples of monomers having an α,β-ethylenic unsaturated group include acrylic acid, methacrylic acid, crotonic acid, itaconic acid, an itaconic acid monoester, maleic acid, a maleic acid monoester, fumaric acid, a fumaric acid monoester, vinylsulfonic acid, styrenesulfonic acid, sulfonated vinylnaphthalene, vinyl alcohol, acrylamide, methacryloxyethyl phosphate, bismethacryloxyethyl phosphate, methacryloxyethylphenyl acid phosphate, ethylene glycol dimethacrylate, diethylene glycohol dimethacrylate, styrene, α-methylstylene, styrene derivatives such as vinyltoluene, vinylcylohexane, vinylnaphthalene, a vinylnaphthalene derivative, an acrylic acid alkylester, an acrylic acid phenylester, a methacrylic acid alkylester, a methacrylic acid phenylester, a methacrylic acid cycloalkylester, a crotonic acid alkylester, an itaconic acid dialkylester, and maleic acid dialkylester.

A copolymer obtained by the copolymerization of a single or a plurality of the above monomers having an α,β-ethylenic unsaturated group is used as a macromolecule dispersing agent. The specific examples include polyvinyl alcohol, polyvinyl pyrrolidone, a styrene-styrene sulfonate copolymer, a styrene-maleic acid copolymer, a styrene-methacrylic acid copolymer, a styrene-acrylic acid copolymer, a vinylnaphthalene-maleic acid copolymer, a vinylnaphthalene-methacrylic acid copolymer, a vinylnaphthalene-acrylic acid copolymer, an alkyl acrylate ester-acrylic acid copolymer, a alkyl methacrylate ester-methacrylic acid, a styrene-alkyl methacrylate ester-methacrylic acid copolymer, a styrene-alkyl acrylate ester-acrylic acid copolymer, a styrene-phenyl methacrylate ester-methacrylic acid copolymer, and a styrene-cyclohexyl methacrylate ester-methacrylic acid copolymer.

The macromolecule dispersing agent is preferably added in a range of from about 0.1 to 3% by weight based on the ink. When the amount of addition exceeds about 3% by weight, a viscosity of the ink becomes high and ejection characteristics of the ink become unstable in some cases. On the other hand, when the amount of addition is below about 0.1% by weight, the dispersion stability of the pigment is sometimes decreased. The amount of addition of the macromolecule dispersing agent is more preferably from about 0.15 to 2.5% by weight, still more preferably from about 0.2 to 2% by weight.

Water-soluble organic solvents contained in the ink include polyvalent alcohols, polyvalent alcohol derivatives, nitrogen-containing solvents, alcohols, and sulfur-containing solvents. Specific examples of the polyvalent alcohols include ethylene glycol, diethylene glycol, propylene glycol, butylene glycol, triethylene glycol, 1,5-pentanediol, 1,2,6-hexanetriol, and glycerin. Specific examples of the polyvalent alcohol derivatives include ethylene glycol monomethyl ether, ethylene glycol monoethyl ether, ethylene glycol monobutyl ether, diethylene glycol monomethyl ether, diethylene glycol monoethyl ether, diethylene glycol monobutyl ether, propylene glycol monobutyl ether, dipropylene glycol monobutyl ether, and ethylene oxide adducts of diglycerin. Specific examples of the nitrogen-containing solvents include pyrrolidone, N-methyl-2-pyrrolidone, cyclohexylpyrrolidone, and triethanolamine. Specific examples of the alcohols include ethanol, isopropyl alcohol, butyl alcohol, and benzyl alcohol. Specific examples of the sulfur-containing solvents include thiodiethanol, thiodiglycerol, sulfolane, and dimethylsulfoxide. Additionally, propylene carbonate, ethylene carbonate, and the like may also be employed.

At least one species of water-soluble organic solvents is preferably used in ink used in the invention. The content of water-soluble organic solvent that is used is from about 1 to 60% by weight, preferably from about 5 to 40% by weight relative to the total amount of the ink. If the amount of water-soluble organic solvent in the ink is below about 1% by weight, a sufficient optical density cannot sometimes be obtained, and if the amount is more than about 60% by weight, a viscosity of the ink becomes high and ejection characteristics of the ink become unstable in some cases.

The ink may contain a surfactant. As a surfactant, a compound that has a structure having both a hydrophilic portion and a hydrophobic portion in the molecule and the like may be used. Surfactants that may be used include anionic surfactants, cationic surfactants, amphoteric surfactants, and nonionic surfactants. Moreover, the aforementioned macromolecule dispersing agent may be used as a surfactant as well.

Among these, nonionic surfactants are preferable in view of dispersion stability of the pigment. Further, in view of controlling of permeability, acetylene glycol, oxyethylene adducts of acetylene glycol, polyoxyethylene alkyl ether, and the like are particularly preferable.

The amount of addition of the surfactant is preferably less than about 10% by weight, more preferably in a range of from about 0.01 to 5% by weight, still more preferably in a range of from about 0.01 to 3% by weight based on a total amount of ink. If the amount of addition is about 10% by weight or more, an optical density and a storage stability of pigment ink are sometimes deteriorated.

To the ink may also additionally be added polyethyleneimine, polyamines, polyvinyl pyrrolidone, polyethylene glycol, ethylcellulose, carboxymethylcellulose, and the like for the purpose of characteristics control such as ink ejection improvement, added a compound and the like such as potassium hydroxide, sodium hydroxide or lithium hydroxide for the adjustment of conductivity and pH, and added as necessary a pH buffer, an antioxidant, a fungicide, a viscosity adjusting agent, a conducting agent, an ultraviolet absorbing agent, a chelating agent, and the like.

The aforementioned treating liquid preferably contains at least one of a component that makes liquid droplets of ink insoluble, a component that makes the viscosity of a liquid droplet of ink to be increased, and a component that causes the pigment in an ink to be aggregated, and in particular preferably contains the component that causes the pigment in an ink to be aggregated. Specifically, for example, for an ink containing a pigment having an anionic group, an electrolyte, a cationic compound and the like may be contained in the treating liquid. Examples of the electrolytes that are effectively used in the invention include salts of: ions such as alkaline metal ions such as lithium ions, sodium ions, or potassium ions, or polyvalent metal ions such as aluminum ions, barium ions, calcium ions, copper ions, iron ions, magnesium ions, manganese ions, nickel ions, tin ions, titanium ions, or zinc ions; and acids such as hydrochloric acid, bromic acid, hydroiodic acid, sulfuric acid, nitric acid, phosphoric acid, thiocyanic acid, or organic carboxylic acids such as acetic acid, oxalic acid, lactic acid, fumaric acid, citric acid, salicylic acid, or benzoic acid, or organic sulfonic acids.

Specific examples of the electrolytes include: salts of alkaline metals such as lithium chloride, sodium chloride, potassium chloride, sodium bromide, potassium bromide, sodium iodide, potassium iodide, sodium sulfate, potassium nitrate, sodium acetate, potassium oxalate, sodium citrate, and potassium benzoate; and salts of polyvalent metals such as aluminum chloride, aluminum bromide, aluminum sulfate, aluminum nitrate, aluminum sodium sulfate, aluminum potassium sulfate, aluminum acetate, barium chloride, barium bromide, barium iodide, barium oxide, barium nitrate, barium thioantimonate, calcium chloride, calcium bromide, calcium iodide, calcium nitrite, calcium nitrate, calcium dihydrogenphosphate, calcium thiocyanate, calcium benzoate, calcium acetate, calcium salicylate, calcium tartrate, calcium lactate, calcium fumarate, calcium citrate, copper chloride, copper bromide, copper sulfate, copper nitrate, copper acetate, iron chloride, iron bromide, iron iodide, iron sulfate, iron nitrate, iron oxalate, iron lactate, iron fumarate, iron citrate, magnesium chloride, magnesium bromide, magnesium iodide, magnesium sulfate, magnesium nitrate, magnesium acetate, magnesium lactate, manganese chloride, manganese sulfate, manganese nitrate, manganese dihydrogenphosphate, manganese acetate, manganese salicylate, manganese benzoate, manganese lactate, nickel chloride, nickel bromide, nickel sulfate, nickel nitrate, nickel acetate, tin sulfate, titanium chloride, zinc chloride, zinc bromide, zinc sulfate, zinc nitrate, zinc thiocyanate, and zinc acetate.

The cationic compounds include primary, secondary, tertiary, and quaternary amines and salts thereof. Specific examples thereof include tetraalkylammonium salts, alkylamine salts, benzalkonium salts, alkylpyridinium salts, imidazolium salts, and polyamines; more specific examples thereof include isopropylamine, isobutylamine, t-butylamine, 2-ethylhexylamine, nonylamine, dipropylamine, diethylamine, trimethylamine, triethylamine, dimethylpropylamine, ethylenediamine, propylenediamine, hexamethyldiamine, diethylenetriamine, tetraethylenepentamine, diethanolamine, diethylethanolamine, triethanolamine, tetramethylammonium chloride, tetraethylammonium bromide, dihydroxyethylsteallylamine, 2-heptadecenyl-hydroxyethylimidazoline, lauryldimethylbenzylammonium chloride, cetylpyridinium chloride, stearamidemethylpyridinium chloride, diallyldimethylammonium chloride polymers, diallylamine polymers and monoallylamine polymers.

Preferable examples of the electrolytes include aluminum sulfate, calcium chloride, calcium nitrate, calcium acetate, magnesium chloride, magnesium nitrate, magnesium sulfate, magnesium acetate, tin sulfate, zinc chloride, zinc nitrate, zinc sulfate, zinc acetate, ammonium nitrate, aminoallylamine polymers, diallylamine polymers, and diallyldimethylammonium chloride polymers.

The treating liquid may contain an anionic compound and the like when ink which contains a pigment having a cationic group on the surface thereof is used. Examples of the anionic compounds that are effectively used in the invention include organic carboxylic acids, organic sulfonic acids, and salts thereof. Specific examples of the organic carboxylic acids include acetic acid, oxalic acid, lactic acid, fumaric acid, citric acid, salicylic acid, benzoic acid, and oligomers and polymers having plurality of these basic structures of the organic carboxylic acids. Specific examples of the organic sulfonic acids include compounds such as benzenesulfonic acid, toluenesulfonic acid, and oligomers and polymers having plurality of these basic structures of the organic sulfonic acids.

The above-describe compounds may be used singly or in a combination of two or more in the treating liquid. The content of the above compound to be used in the treating liquid is preferably from about 0.1 to 15% by weight, more preferably from about 0.5 to 10% by weight relative to a total amount of the ink.

The treating liquid may be made to contain a surfactant as in the ink. Examples of the surfactants used in the treating liquid are similar to those mentioned above.

An ink jet recording apparatus of the invention may also, normally, include a maintenance unit for maintaining the recording head during non-printing time, for the purpose of maintenance or recovery of properties such as ejection properties. The maintenance unit generally has at least a cap that collects on its inner surfaces printing liquid, which is ejected by dummy jetting from the recording head and/or discharged by suction utilizing a pump or the like.

Also, with respect to high speed printing, the higher the conveying speed of the recording medium, the better, however if the speed is too high, the airflow generated against the nozzle surface also becomes too fast, and the scattering of mist increases in likelihood. In the invention, however, there is provided a mist collecting device having a catalytic decomposing device located downstream of the recording head, even in an ink jet recording apparatus of the aforementioned single-pass system. This makes it capable of suppressing the scattering of mist even though the conveying speed of recording medium is increased. This enables the suppression of scattering of mist, leading to suppression of image deterioration and staining of the inside of the apparatus, even when the conveying speed of a recording medium is in the high-speed range of about 100 mm/s or more.

In view of image quality enhancement (increasing high definition), a smaller liquid amount per drop of the aforementioned printing liquids that are ejected from the recording heads is more preferable. However, if the liquid droplet to be ejected becomes smaller, the mist generated is expected to become finer, whereby the residence property of the mist increases, leading to more easy scattering of the mist.

In an ink jet recording apparatus of the invention as described above, however, a mist collecting device having a catalytic decomposing device is provided downstream of the recording head, and thus the scattering of a mist can be suppressed even though the liquid amount per drop is small. This can suppress the scattering of a mist even when the liquid amount per drop is about 10 pl or less, the amount that is suitable for image quality enhancement, leading to the suppression of image deterioration and staining of the inside of the apparatus.

The present embodiment described an ink jet printer of an ink jet system, however, the invention is not limited to such a system and ink jet systems that may be used include thermal ink jet systems, piezo type ink jet, continuous flow type ink jet, and electrostatic attraction type ink jet systems.

Also, inks that may be used and applied include water-based inks, oil-based inks, so-called solid inks that is solid at room temperature, and solvent inks. Any pigment and dye may be utilized as coloring material in the inks.

### EXAMPLES

The present invention will be specifically described in terms of examples hereinafter.

Fabrication of an Ink Set for Ink Jet

Suitable amounts of a coloring agent solution, a water-soluble organic solvent, a surfactant, ion exchange water, and the like are mixed in such a way that a predetermined composition is prepared, and the mixture solution is mixed and agitated. The resulting liquid is passed through a 5 μm filter, whereby each desired solution is obtained.

Ink Set 1 for Ink Jet

| | |
|---|---|
| Ink 1 (black ink) | |
| CAB-0-JET ®300 (self-dispersible pigment | 4% by weight |
| having carboxylic group/manufactured by Cabot | |
| Corporation) | |
| Styrene-acrylic acid copolymer (acid value: | 1% by weight |
| 100/neutralization value:95%) | |
| Diethylene glycol | 15% by weight |
| Thiodiglycol | 2.5% by weight |
| Diethylene glycol monobutyl ether | 2.5% by weight |
| Acetylene glycol ethylene oxide adduct | 0.2% by weight |
| Ion exchange water | balance |
| Ink 2 (cyan ink) | |
| C.I. Pigment Blue 15:3 (pigment having | 4% by weight |
| sulfonic group) | |
| Diethylene glycol | 20% by weight |
| Propylene glycol | 2.5% by weight |
| Diethylene glycol monobutyl ether | 2.5% by weight |
| Acetylene glycol ethylene oxide adduct | 1% by weight |
| Furancarboxylic acid | 1% by weight |
| Sodium hydroxide | 0.2% by weight |
| Ion exchange water | balance |
| Ink 3 (magenta ink) | |
| C.I. Pigment Red 122 (pigment having | 4% by weight |
| sulfonic group) | |
| Diethylene glycol | 15% by weight |
| Triethylene glycol | 5% by weight |
| Sulfolane | 2.5% by weight |
| Diethylene glycol monobutyl ether | 2.5% by weight |
| Acetylene glycol ethylene oxide adduct | 1% by weight |
| Ion exchange water | balance |
| Ink 4 (yellow ink) | |
| C.I. Pigment Yellow 128 (pigment having | 4% by weight |
| sulfonic group) | |
| Diethylene glycol | 20% by weight |
| Diethylene glycol monobutyl ether | 5% by weight |
| Acetylene glycol ethylene oxide adduct | 1% by weight |
| Ion exchange water | balance |
| Treating liquid | |
| Diethylene glycol | 25% by weight |
| Magnesium nitrate hexahydrate | 5% by weight |
| Acetylene glycol ethylene oxide adduct | 1% by weight |
| Ion exchange water | balance |
| Printing Conditions | |

For printing, five nozzle surfaces having 600 dpi and 4960 nozzles per color are arranged as a recording head. A thermal ink jet apparatus for evaluation and trial manufacture is used that is provided with a full line head as indicated in FIG. 1; each of the above-described inks 1 to 4 and the above-described treating liquid are placed in each head in the order mentioned above.

A mist collecting device A (capable of placement and removal downstream of the above ink jet recording apparatus) is prepared that has a vane-shaped titanium oxide-coated collector (titanium oxide particle diameter: 25 nm, specific surface area: 150 m²/g, binder resin: fluorine resin, amount of titanium oxide coating: 50 g/m²) that uses a ceramic substrate. A mist collecting device B is prepared that is similar to mist collecting device A except that the collector is not coated with titanium oxide. These mist collecting devices each have fans for sucking air into the exhausts thereof. The flow rates of air are at about 20 mm/sec at the suction ports of the mist collecting devices when the fans are being driven.

Mist collecting device A above has a black light as a light irradiation device provided at a position located above the collector thereof, like that in FIG. 4B, so that the collector is irradiated with light at a light intensity of 1 mJ/cm².s. Additionally, the collector is irradiated with light only when the printer of the apparatus is running.

A Multi-Ace paper sheet (trade name, manufactured by Fuji Xerox Co., Ltd.), or the like is used. The amount of ejection is set equal to about 10 pl, the amount of ink placement is set to about 0.03 ml/m², the weight ratio of the treating liquid to the ink (treating liquid/ink) for pixel formation is set to 1/2, and the printing speed (paper sheet conveying speed) is set to 105 mm/sec, with printing using A4 and each color with a 5% coverage pattern. Also, printing is carried out under standard conditions (temperature: 23±0.5° C., humidity: 55±5% RH).

### Example and Comparative Examples

Under the above printing conditions, printing testing is carried out up to about 60000 sheets for three specifications below by means of the above-described ink jet recording apparatuses.
(1) Printing with mist collecting device A, with the fan driven (specification of the invention).
(2) Printing with mist collecting device B, with the fan driven.
(3) Printing without using a mist collecting device.

In printing of each specification, an HG coated paper (manufactured by Fuji Xerox Co., Ltd.) specifically for ink jet printing is pasted on the back surface of the cover of an ink jet recording apparatus and the optical density ODpv of the coated paper is determined for every 1000 sheets by means of an optical density meter (trade name: X-RITE 540, manufactured by X-Rite Ltd.). An optical density change from the initial optical density OD_{IN} (0.1 in this example) is calculated; the density change ΔOD is expressed in terms of equation (1) below:
ΔOD=OD_{PV}−OD_{IN} (1)

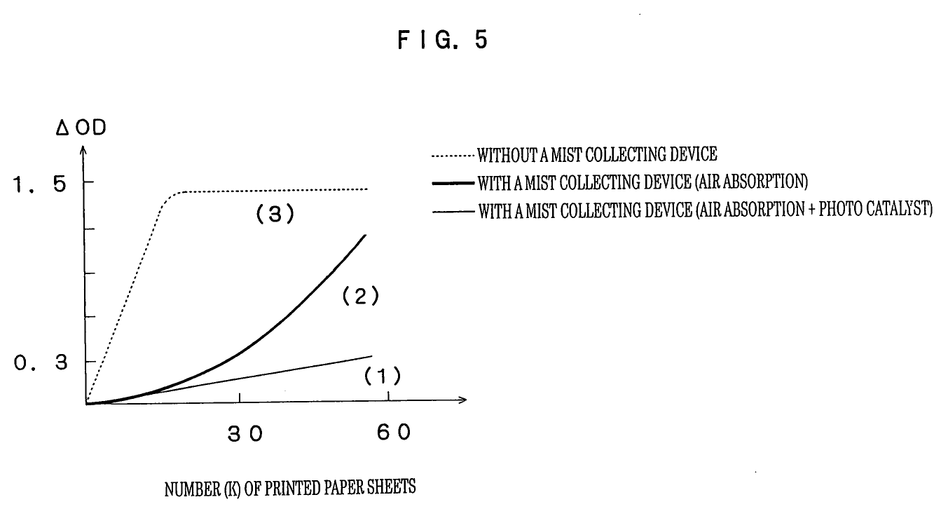

Changes in ΔOD with increasing number of printed paper sheets are shown in FIG. 5.

As indicated in FIG. 5, for the case provided with the usual mist collecting device (specification of (2) above), the rate of increase in the initial ΔOD is improved as compared with the case (specification of (3) above) without a conventional mist mechanism. However, the increase in ΔOD with increasing numbers of paper sheets cannot be restrained. On the other hand, the mist collecting device (specification of (1) above) equipped with the catalytic decomposing device of the invention can suppress an increase in ΔOD to a large number of printed paper sheets.

What is claimed is:

1. An ink jet recording apparatus which comprises a recording head having at least one nozzle which ejects liquid droplets of ink to record an image on a recording medium, wherein
the ink jet recording apparatus includes a mist collecting device for collecting a mist that does not impact against the recording medium and a catalytic decomposing device for decomposing organic components in the mist using a catalyst.

2. The ink jet recording apparatus of claim 1, wherein the catalyst comprises a photo semiconductor catalyst.

3. The ink jet recording apparatus of claim 2, wherein the photo semiconductor catalyst comprises titanium oxide.

4. The ink jet recording apparatus of claim 1, wherein the mist collecting device has an air suction device.

5. The ink jet recording apparatus of claim 2, wherein the mist collecting device has an air suction device.

6. The ink jet recording apparatus of claim 3, wherein the mist collecting device has an air suction device.

7. The ink jet recording apparatus of claim 1, wherein the mist collecting device has a collector for collecting the mist.

8. The ink jet recording apparatus of claim 2, wherein the mist collecting device has a collector for collecting the mist.

9. The ink jet recording apparatus of claim 3, wherein the mist collecting device has a collector for collecting the mist.

10. The ink jet recording apparatus of claim 7, wherein the collector includes the catalyst.

11. The ink jet recording apparatus of claim 8, wherein the collector includes the catalyst.

12. The ink jet recording apparatus of claim 9, wherein the collector includes the catalyst.

13. The ink jet recording apparatus of claim 7, wherein the collector extends over substantially the entire area through which airflow passes in the mist collecting device.

14. The ink jet recording apparatus of claim 8, wherein the collector extends over substantially the entire area through which airflow passes in the mist collecting device.

15. The ink jet recording apparatus of claim 9, wherein the collector extends over substantially the entire area through which airflow passes in the mist collecting device.

16. The ink jet recording apparatus of claim 1, wherein the catalytic decomposing device has a light irradiation device.

17. The ink jet recording apparatus of claim 1, wherein the recording head is provided with nozzles over the entire width of a recording region.

18. The ink jet recording apparatus of claim 1, wherein the recording head further comprises a nozzle that ejects liquid droplets of a treating liquid containing at least one component selected from the group consisting of a component that makes liquid droplets of ink insoluble, a component that makes a viscosity of liquid droplets of ink increase, and a component that causes pigment in ink to aggregate.

19. The ink jet recording apparatus of claim 18, wherein the treating liquid contains the component that causes pigment in ink to aggregate.
